(19) United States
(12) Patent Application Publication
(10) Pub. No.: US 2020/0399929 A1
(43) Pub. Date: Dec. 24, 2020

(54) MULTI-PARTY PHYSICAL ACCESS CONTROLS

(71) Applicant: International Business Machines Corporation, Armonk, NY (US)

(72) Inventors: Stanley Bryan Hardter, BALDWINSVILLE, NY (US); HuyAnh Dinh Ngo, STERLING HEIGHTS, MI (US); Adam Lee Griffin, DUBUQUE, IA (US); Seng Chai Gan, ASHBURN, VA (US)

(21) Appl. No.: 16/449,622

(22) Filed: Jun. 24, 2019

(51) Int. Cl. E05B 19/00; G07C 9/00; H04L 29/08; H04L 9/32; H04W 4/80; H04L 9/06

(52) U.S. Cl. CPC E05B 19/0005; G07C 9/00571; H04L 67/104; H04L 2209/38; H04W 4/80; H04L 9/0643; H04L 9/3231

(57) ABSTRACT

Ensuring physical access control of a lockbox according to a contract. Parties to the contract interact with the lockbox according to contractual requirements recorded to a ledger accessible over a network. The ledger linking access activity of the parities using cryptography. The lockbox is opened with a credential provided over the network and secured automatically upon closing of the lockbox such that the credential no longer opens the lockbox.

### BACKGROUND

The present invention relates generally to the field of access management, and more particularly, to access management utilizing security arrangements.

A safe deposit box, also known as a safety deposit box, is an individually secured container, usually held within a larger safe or vault. Safe deposit boxes are generally located in banks, post offices, and other institutions for safe-guarding valuables. Safe deposit boxes are used to store valuable possessions that need protection from theft, fire, flood, tampering, and other perils. Many hotels, resorts, and cruise ships offer safe deposit boxes for use by their patrons. A safe deposit box is typically leased to a customer by a safe deposit box owner for secure storage of personal items.

A blockchain is a decentralized, distributed, and public digital ledger for recording and/or linking multi-party interactions taking place across many computers in such a way that recorded interactions cannot be altered retroactively without altering all subsequent records. Blockchain allows users to verify and audit multi-party interactions independently. A blockchain database is managed autonomously using a peer-to-peer network and a distributed timestamping server. A blockchain is authenticated by mass collaboration powered by the collective self-interests of the parties involved.

### SUMMARY

In one aspect of the present invention, a method, a computer program product, and a system includes: (i) monitoring physical access of a lockbox under controlled access according to a contract governing control of the lockbox; (ii) generating an authentication of a user by determining a first biometric reading stored for reference matches a second biometric reading submitted for the authentication, the first biometric reading associated with a user having authority to gain physical access to the lockbox according to the contract; (iii) recording an identity of the authenticated user to a ledger accessible over a peer-to-peer network of parties to the contract, the ledger supporting the contract by linking access activity of the parties using cryptography, the authenticated user being the user for whom the authentication was generated; (iv) identifying a request for physical access to the lockbox submitted by the authenticated user; (v) responsive to identifying an acceptance of the request by an authorized party of the contract, providing to the authenticated user a credential permitting access to the lockbox; (vi) responsive to use of the credential to open the lockbox, recording to the ledger the request associated with the authenticated user and an access event initiated by the authenticated user; and (vii) recording a closing event on the ledger.

### BRIEF DESCRIPTION OF THE DRAWINGS

FIG. 1 is a functional block diagram illustrating a computing environment for managing multi-party physical access of safe deposit boxes, in accordance with a first embodiment of the present invention.

FIG. 2 is a flowchart depicting operations for managing multi-party physical access activities, on a computing device within the computing environment of FIG. 1, in accordance with the first embodiment of the present invention.

FIG. 3 is a block diagram view of a second embodiment of a system according to the present invention.

FIG. 4 is a block diagram view of a third embodiment of a system according to the present invention.

### DETAILED DESCRIPTION

Ensuring physical access control of a lockbox according to a contract. Parties to the contract interact with the lockbox according to contractual requirements recorded to a ledger accessible over a network. The ledger linking controlled access activity of the parities using cryptography. The lockbox is opened with a credential provided over the network and secured automatically upon closing of the lockbox such that the credential no longer opens the lockbox.

The term lockbox, as used herein, is an enclosed container that is secured against unauthorized access such that both the opening and closing of the enclosed container is controlled. Throughout this document a lockbox is also referred to as a controlled area, a secure container, and a safe deposit box. Examples of a lockboxes include: (i) safe deposit boxes, generally located in banks, post offices, and other institutions for safe-guarding valuables; (ii) safes, such as may be found in hotel rooms, resorts, and cruise ships; and (iii) secure access lockers provided for package delivery.

Managing controlled access to a safe deposit box involves authenticating the identity of a user via biometric authentication, identifying a request for safe deposit box access, identifying an acceptance of the request, generating an access credential for access to the safe deposit box, and identifying the opening and the closing of the safe deposit box, while recording and/or linking access activities to a shared ledger.

Some embodiments of the present invention recognize that, for a user to gain access to a safe deposit box, the user is often burdened with authentications and interactions with other persons who must be present to manually record and monitor user access. For example, the user may be required to provide an identification card for identity verification. Oftentimes, identity verification requires other persons to validate the identification. Upon validation, the user may be accompanied to the safe deposit box where an access log is manually updated to record the access activity. Access activity includes the unlocking and locking (or the opening and closing) of the safe deposit box. Performing the access activity often requires the user to carry a safe deposit box key and be joined by another person having an additional safe deposit box key. Manually logging access activity consists of a local activity tracking method, such as a log book record. Manually controlling access activity with a log book takes a lot of time and often requires other persons to handle requests to access the safe deposit box. Certain control features fail when managed manually, such as having a key for access where possession of the key is one step toward manually authenticated access. The user is often required to wait for other persons to become available in order to request access to a safe deposit box. Further, other persons must be present during the access activity.

Some embodiments of the present invention provide a method to automate the control of safe deposit box access activity, to ensure secure authentication and authorization processes, and to allow digital key access to a safe deposit box. A distributed ledger, or shared ledger, provides for a consensus of replicated, shared, and synchronized digital data geographically distributed across various sites, countries, or entities. The shared ledger is oftentimes accessed over a peer-to-peer network and controlled via set of consensus algorithms to ensure replication across nodes. As discussed above, one example of shared ledger use is in the blockchain system. Other shared ledger examples are found in block directed acyclic graphs (blockDAG) and transaction-based directed acyclic graphs (TDAG).

In some embodiments, controlling safe deposit box access activity employs a shared ledger that is part of a blockchain platform on a peer-to-peer network such that the data recorded to the ledger is consensually shared among multiple parties under contract with one another or otherwise part of an agreement to do business together. According to some embodiments of the present invention, the shared ledger includes sequentially linking safe deposit box access activities of all parties under contract. In some embodiments, identity authentication utilizes biometric reader technology. In some embodiments, a Li-Fi network is utilized for secure authentication. Some embodiments of the present invention provide a method for managing safe deposit box access in a nonrepudiation online environment by using a blockchain platform. Nonrepudiation is the mutual assurance that one party cannot repudiate (or reject) the validity of a certain action or activity of another party.

Some embodiments of the present invention provide advantages for the parties involved with safe deposit box access activities. In some embodiments of the present invention, biometric authentication, Li-Fi network utilization, and/or digital key access reduces the idle time of users by providing for automated access control and facilitating a secure authentication and authorization process. Furthermore, a blockchain platform saves time, reduces costs, reduces risks, and increases trust by providing for automated access control in a nonrepudiation online environment.

Embodiments of the present invention will now be described in detail with reference to the Figures. It is to be understood that these embodiments are described only for the purpose of illustration and help those skilled in the art to understand and implement the present invention, without suggesting any limitation as to the scope of the invention. The invention described herein can be implemented in various manners other than the ones explicitly described herein.

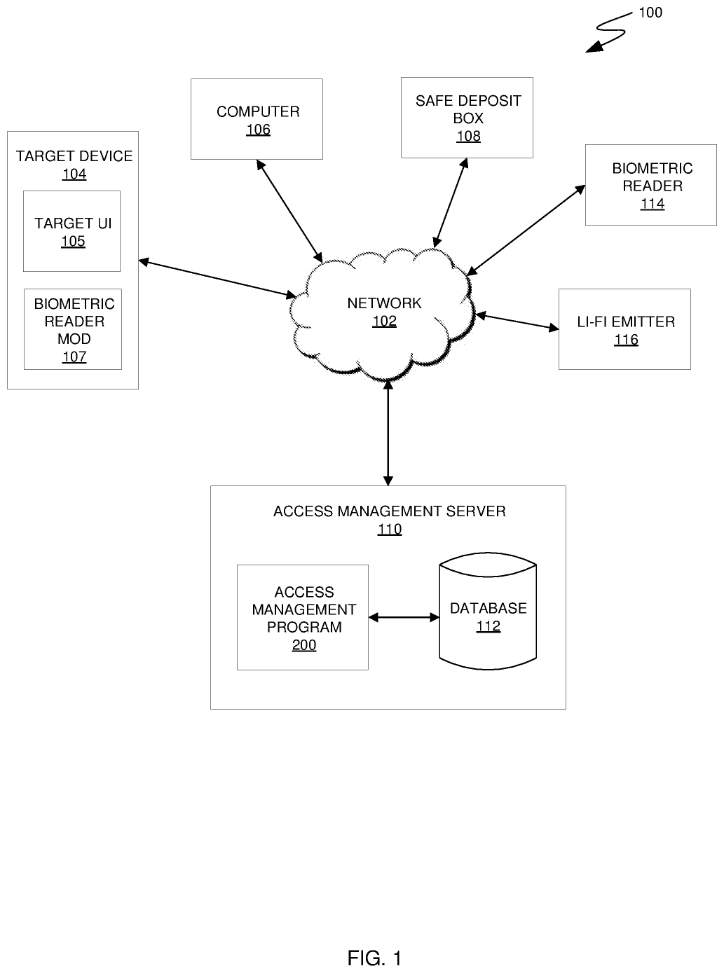

FIG. 1 is a functional block diagram illustrating a computing environment for managing multi-party physical access of safe deposit boxes, in accordance with an embodiment of the present invention. For example, FIG. 1 is a functional block diagram illustrating computing environment 100. Computing environment 100 includes target device 104, computer 106, safe deposit box 108, access management server 110, biometric reader 114, and Li-Fi emitter 116 connected over network 102. Target device 104 includes target user interface (target UI) 105 and biometric reader module 107. Access management server 110 includes access management program 200 and database 112.

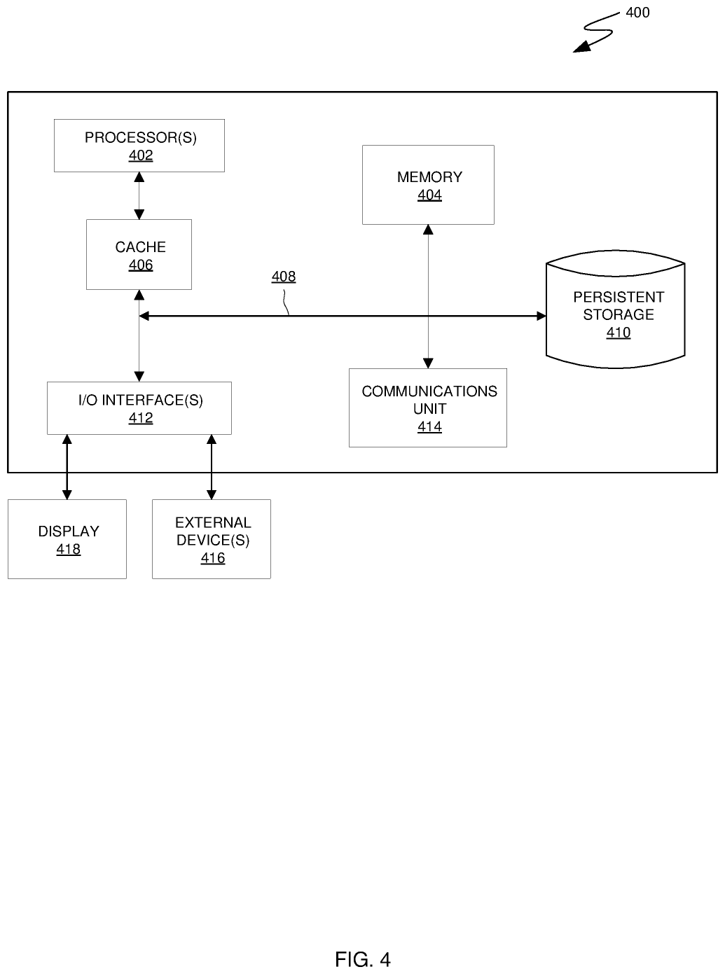

In some embodiments of the present invention, access management server 110 is a computing device that can be a standalone device, a server, a laptop computer, a tablet computer, a netbook computer, a personal computer (PC), or a desktop computer. In some embodiments, access management server 110 represents a computing system utilizing clustered computers and components to act as a single pool of seamless resources. In general, access management server 110 can be any computing device or a combination of devices with access to some or all of target device 104 and computer 106, and with access to and/or capable of executing access management program 200. Access management server 110 may include internal and external hardware components, as depicted and described in further detail with respect to FIG. 4.

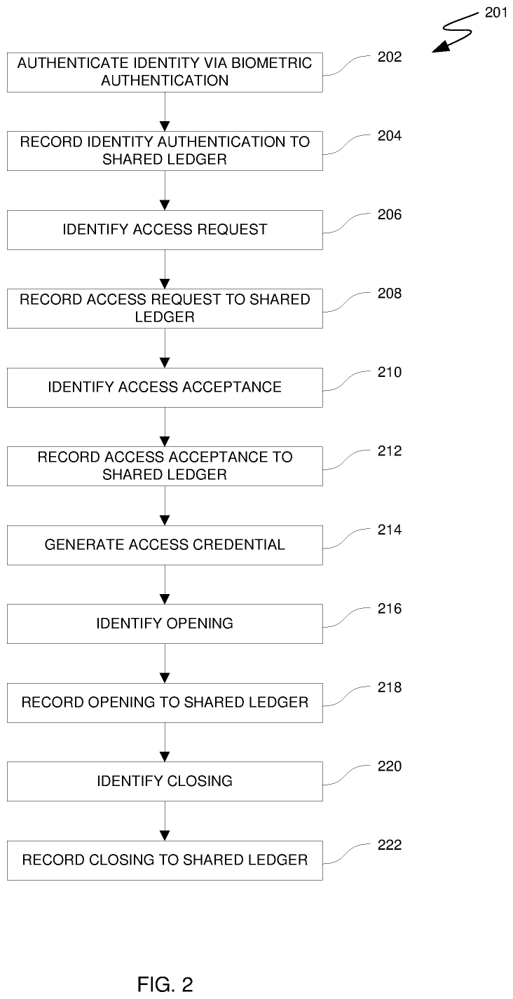

In some embodiments of the present invention, access management program 200 is stored on access management server 110. In some embodiments, access management program 200 resides on another computing device (e.g., target device 104), provided it can access and/or receive data from target device 104. In some embodiments, access management program 200 is stored externally and accessed through a communication network, such as network 102. Operations executed by access management program 200 are discussed in greater detail with respect to FIG. 2.

In general, access management program 200 operates to manage physical access of multiple parties to a controlled area, such as the area within a safe deposit box. According to some embodiments of the present invention, access management program 200 authenticates the identity of a user via biometric authentication, identifies a request for physical access, identifies acceptance of the request, generates an access credential, and identifies access activity with the access credential, while recording access activities to a shared ledger in a blockchain platform.

Database 112 is a data repository that may be written to and read by access management program 200. According to some embodiments of the present invention, access activities are recorded to a shared ledger and biometric identification readings are stored to a database, such as database 112. In some embodiments of the present invention, database 112 is written to and read by programs and entities outside of computing environment 100 to populate the repository with information regarding access activities recorded to a shared ledger and biometric identification readings. Contents of database 112 may be distributed among computing devices in FIG. 1.

Network 102 can be, for example, a local area network (LAN), a wide area network (WAN) such as the Internet, or a combination of the two, and may include wired, wireless, fiber optic or any other connection known in the art. In general, network 102 can be any combination of connections and protocols that will support communications between access management server 110 and target device 104, in accordance with a desired embodiment of the present invention. In some embodiments of the present invention, network 102 is a Li-Fi network. The Li-Fi network is described in greater detail with respect to FIG. 2. In some embodiments of the present invention, network 102 is a peer-to-peer network that is part of a blockchain platform such that data is consensually shared among multiple parties under contract with one another or otherwise part of an agreement to do business together.

In some embodiments of the present invention, target device 104 is a computing device that can be a standalone device, a server, a laptop computer, a tablet computer, a netbook computer, a personal computer (PC), a desktop computer, a personal digital assistant (PDA), a smart phone, or any programmable electronic device capable of communicating with access management server 110 via network 102. In some embodiments, target device 104 represents a computing system utilizing clustered computers and components to act as a single pool of seamless resources. In general, target device 104 can be any computing device or a combination of devices with access to access management server 110, and with access to and/or capable of executing access management program 200. In some embodiments, a user of target device 104 can input access requests and/or utilize biometric authentication capabilities. Target device 104 may include internal and external hardware components, as depicted/described in further detail with respect to FIG. 4.

Target device 104 includes a user interface (UI), target UI 105, which executes locally on target device 104 and operates to provide a UI to a user of target device 104. Target UI 105 further operates to receive user input from a user via the UI, thereby enabling the user to interact with target device 104. In some embodiments of the present invention, target UI 105 provides a user interface enabling a user of target device 104 to interact with access management program 200 of access management server 110 via network 102. In various examples, the user interacts with access management program 200 to input access requests and receive access credentials. In some embodiments, target UI 105 is located on target device 104. In some embodiments, target UI 105 is located on another computing device (e.g., access management server 110), provided target UI 105 can access and is accessible by target device 104 and access management program 200.

Target device 104 includes a biometric reader module, biometric reader mod 107, which executes locally on target device 104 and operates to provide a module for biometric identification readings of a user of target device 104 for biometric authentication. Biometric authentication is a security process that relies on the unique biological characteristics of an individual to verify that individual is actually the individual. Biometric authentication systems compare a biometric identification reading to biometric identification reading data confirmed to be authentic and stored in a database, such as database 112. If the biometric identification reading matches the stored biometric reading data, authentication is confirmed. Types of biometric identification readings include retina scans, iris recognition, fingerprint scanning, facial recognition, and voice identification. In some embodiments of the present invention, biometric reader mod 107 is located on target device 104. In some embodiments, biometric reader mod 107 is located on another computing device (e.g., access management server 110), provided biometric reader mod 107 can access and is accessible by target device 104 and access management program 200.

Computer 106 is a computing device that can be a standalone device, a server, a laptop computer, a tablet computer, a netbook computer, a personal computer (PC), a desktop computer, a personal digital assistant (PDA), a smart phone, or any programmable electronic device capable of communicating with access management server 110 via network 102. In some embodiments of the present invention, computer 106 represents a computing system utilizing clustered computers and components to act as a single pool of seamless resources. In general, computer 106 can be any computing device or a combination of devices with access to access management server 110, and with access to and/or capable of executing access management program 200. In some embodiments, computer 106 can receive access requests and can input access acceptances. Computer 106 may include internal and external hardware components, as depicted/described in further detail with respect to FIG. 4.

Safe deposit box 108 is a safe deposit box capable of communicating with access management server 110 via network 102. In some embodiments of the present invention, safe deposit box 108 can be configured to open via an access credential generated by access management program 200. In some embodiments, safe deposit box 108 can monitor and control when safe deposit box 108 is opened and closed. In some embodiments, safe deposit box 108 contains sensors that can determine when the safe deposit box is opened and closed. Opening and closing of safe deposit box 108 can be recorded to a shared ledger on a blockchain platform, stored in a database, such as database 112, and such access activities may be linked according to an order, such as chronological order in a way that the linked activities cannot be broken without changing the entire record of access.

Biometric reader 114 is a biometric reader device capable of taking biometric identification readings of a user for biometric authentication. Biometric authentication is a security process that relies on the unique biological characteristics of an individual to verify the individual's identity. Biometric authentication systems compare a biometric identification reading to biometric identification reading data confirmed to be authentic and stored in a database, such as database 112. If the biometric identification reading matches the stored biometric reading data, authentication is confirmed. Types of biometric identification readings include retina scans, iris recognition, fingerprint scanning, facial recognition, and voice identification.

Li-Fi emitter 116 is a device capable of emitting light in order to transmit and receive data with a device. Li-Fi is a visible light communications system that is capable of transmitting data at high speeds over the visible light, ultraviolet, and infrared spectrums. Li-Fi emitter 116 may include any Li-Fi enabled LED light. Li-Fi emitter 116 converts data into an electrical signal that is converted into a beam of light. A smart device, or mobile device, such as a smart phone, with Li-Fi capabilities, may convert the beam of light into an electrical signal, which in turn is converted into readable data. Target device 104 may be a smart phone. In some embodiments of the present invention, Li-Fi emitter 116 emits light to transmit identity authentication, access requests, access acceptances, and/or to support other access activities.

FIG. 2 is a flowchart depicting operations for managing access activities, on a computing device within the computing environments of FIG. 1, in accordance with an embodiment of the present invention. For example, FIG. 2 is a flowchart depicting operations 201 of access management program 200 on access management server 110 within computing environment 100. In other examples, FIG. 2 is a flowchart depicting operations of access management program 200 on target device 104 within computing environment 100. In yet other examples, FIG. 2 is a flowchart depicting operations of access management program 200 on computer 106 within computing environment 100. In different embodiments, there are multiple variations of the order of the steps that may be applied. For example, in some embodiments, the order in which identity authentication and identification of access requests may differ from the embodiment depicted in FIG. 2.

Access management program 200 authenticates the identity of a user seeking physical access to a controlled area via biometric authentication (step 202). In some embodiments of the present invention, the user provides biometric data via a biometric reader device, such as biometric reader 114 of FIG. 1, to authenticate the identity of the user. The biometric reader is capable of taking biometric identification readings of an individual for biometric authentication. Biometric authentication is a security process that relies on the unique biological characteristics of an individual to verify that individual is actually the individual. Biometric authentication systems compare a biometric identification reading to biometric identification reading data confirmed to be authentic and stored in a database, such as database 112. If the biometric identification reading matches the stored biometric reading data, identity authentication is confirmed. Examples of biometric identification readings include retina scans, iris recognition, fingerprint scanning, facial recognition, and voice identification.

In an example, Abel desires physical access to safe deposit box number 508. Biometric identification reading data of all individuals authorized to access safe deposit boxes in a particular vault are stored in a database for biometric authentication purposes. The stored biometric identification reading data is used for comparison with biometric identification readings of individuals seeking physical access to a particular safe deposit box. Abel utilizes a retina scanner to provide a biometric identification reading. Access management program 200 compares the biometric identification reading provided by Abel to stored biometric identification reading data of persons authorized to access safe deposit box number 508. In this example, the retina scanner obtains a retina scan and transmits the retina scan data to access management program 200. Access management program 200 compares the blood vessel patterns of the retina scan data with the blood vessel patterns stored in the database as representing persons authorized to access safe deposit box number 508. In this example, the retina scan data provided by Able matches an authorized retina scan stored in the database. Accordingly, access management program 200 authenticates Abel for physical access to safe deposit box number 508.

In some embodiments of the present invention, the identity of the user is authenticated using a biometric reader on a smart device, such as biometric reader mod 107 of target device 104 of FIG. 1. In some embodiments, the smart device is connected to a Li-Fi network via a light beam emitted from a Li-Fi emitter. A Li-Fi network comprises of a visible light communications system that is capable of transmitting data at high speeds over the visible light, ultraviolet, and infrared spectrums. A Li-Fi emitter, such as Li-Fi emitter 116, is a device capable of emitting light in order to transmit and receive data with a device. The Li-Fi emitter converts data into an electrical signal that is converted into a beam of light. A Li-Fi enabled smart device can convert this beam of light into an electrical signal, which in turn can be converted into readable data. Utilizing a Li-Fi network enforces a physical presence requirement for persons seeking physical access to a controlled area. Because the beam of light from a Li-Fi emitter is how data is transmitted, a Li-Fi enabled smart device must be located within a physical boundary of the Li-Fi network. According to some embodiments of the present invention, a smart device is a mobile device carried by the user having capability to communication over a network as described herein. One example of a smart device is a smart phone. Other examples of smart devices include: a laptop computer, a tablet computer, and a netbook computer.

In some embodiments of the present invention, a Li-Fi enabled smart device can connect with a Li-Fi network by physically interacting with a beam of light emitted by a Li-Fi emitter. Once the Li-Fi enabled smart device is connected to the Li-Fi network, a user may utilize a biometric reader module located on the Li-Fi enabled smart device to authenticate the identity of the user in a similar manner described previously in relation to utilization of a biometric reader device.

In an example, Baker desires physical access to safe deposit box number 805. Biometric identification reading data of all individuals authorized to access safe deposit boxes in a particular vault are stored in a database for biometric authentication purposes. The stored biometric identification reading data is used for comparison with biometric identification readings of individuals seeking physical access to a particular safe deposit box. Baker utilizes a Li-Fi enabled smart device to connect to a Li-Fi network by physically interacting with a beam of light emitted by a Li-Fi emitter. Once the Li-Fi enabled smart device is connected to the Li-Fi network, Baker utilizes a fingerprint scanner located on the smart device to provide a biometric identification reading. Access management program 200 compares the biometric identification reading provided by Baker to stored biometric identification reading data of persons authorized to access safe deposit box number 805. In this example, the fingerprint scanner obtains a fingerprint scan and transmits the fingerprint scan data to access management program 200. Access management program 200 compares the patterns of arches and branches of the fingerprint scan data with the patterns of arches and branches stored in the database as representing persons authorized to access safe deposit box number 805. In this example, the fingerprint scan data provided by Baker matches an authorized fingerprint scan stored in the database. Accordingly, access management program 200 authenticates Baker for physical access to safe deposit box number 805.

Access management program 200 records the identity of the authenticated user to a shared ledger (step 204). In some embodiments of the present invention, the shared ledger is part of a blockchain platform on a peer-to-peer network such that the data recorded to the ledger is consensually shared among multiple parties under contract with one another or otherwise part of an agreement to do business together. A shared ledger is a type of database that is shared, replicated, and synchronized among the members of a decentralized network. The shared ledger records the transactions, such as the exchange of assets or data, among the parties in the network. Every record in the shared ledger has a timestamp and unique cryptographic signature, thus making the ledger an auditable, immutable history of all transactions in the network. In some embodiments of the present invention, the shared ledger is stored in a database, such as database 112, accessible by members of the blockchain platform network.

The blockchain platform uses a consensus protocol to agree on ledger content, and cryptographic hashes and digital signatures to ensure the integrity of recorded interactions. Consensus ensures that the shared ledger is exactly the same for all parties, which lowers the risk of fraudulent transactions, since tampering would have to occur across many places at exactly the same time. Cryptographic hashes, such as the SHA256 computational algorithm, ensure that any alteration to transaction input results in a different hash value being computed, which indicates potentially compromised interaction recordation. Digital signatures ensure that interactions originated from senders (signed with private keys) and not from imposters. The consensus protocol is part of a smart contract between parties involved with safe deposit box access activities. The smart contract encapsulates terms of agreement for the interactions that take place on the blockchain platform. The terms of agreement for the parties involved with safe deposit box access activities are equal under the consensus protocol.

In some embodiments of the present invention, access management program 200 records the identity of the authenticated user to the shared ledger. In some embodiments, access management program 200 records the authentication of a user after a successful authentication to the shared ledger. In some embodiments, access management program 200 records the timestamp of authentication and other identifying information regarding the authentication, such as the location of activity, the name of the device used, and the activity name. In some embodiments, the biometric reading is recorded in the shared ledger. The recordation of the identity, the timestamp, the other identifying information, and the biometric reading recorded in the shared ledger may be encrypted with a unique cryptographic signature. The cryptographic signature signifies that the authentication was conducted for the unique user. In some embodiments, access management program 200 records failed authentications to the shared ledger.

Access management program 200 identifies an access request (step 206). The access request is a request for physical access to a specific controlled area, such as a numbered safe deposit box. In some embodiments of the present invention, a user submits an access request after authentication of the identity of the user. In some embodiments, a biometric reader device, such as biometric reader 114 of FIG. 1, provides a user seeking physical access with an option to submit an access request after a successful authentication. In some embodiments, a device other than the biometric reader is used to submit an access request. In some embodiments, a user interface of a target device, such as target UI 105 of target device 104 of FIG. 1, is used to submit an access request. In some embodiments, an access request is submitted via a Li-Fi network from a Li-Fi enabled smart device, such as target device 104. In some embodiments, an access request is sent to a device capable of receiving access requests, such as computer 106.

Access management program 200 records the access request to the shared ledger (step 208). In some embodiments of the present invention, the shared ledger is controlled by a blockchain platform. In some embodiments, access management program 200 records a timestamp and other identifying information of the request. Identifying information may include: the location of activity, the name of the device used, and the activity name. In some embodiments, the recorded access request is encrypted with a unique cryptographic signature. The cryptographic signature signifies that the access request was submitted by a unique user.

Access management program 200 identifies acceptance of the access request (step 210). The acceptance is an authorization for physical access to a specific controlled area, such as a numbered safe deposit box. In some embodiments, the acceptance is submitted to the requesting user. In some embodiments, a computer, such as computer 104 of FIG. 1, prompts an administrator with an option to verify the identity of the requesting user prior to acceptance. In some embodiments, a computer prompts an administrator with an option to send additional security questions to the requesting user prior to acceptance of the access request. In some embodiments, access management program 200 sends additional security questions to the requesting user via text message or phone call as a secondary security measure prior to accepting the request for access. In some embodiments, access management program 200 sends the additional security questions through a Li-Fi network.

Access management program 200 records the acceptance of the access request to the shared ledger (step 212). In some embodiments of the present invention, the shared ledger is controlled by a blockchain platform. In some embodiments of the present invention, access management program 200 records a timestamp and other identifying information of the acceptance, such as the location of activity, the name of the device used, and the activity name. In some embodiments, the recorded acceptance is encrypted with a unique cryptographic signature. The cryptographic signature signifies that the acceptance was provided by a particular person or entity.

Access management program 200 generates a credential for access to a secure container, or area (step 214). The credential uniquely provides physical access to a specific controlled area, such as a numbered safe deposit box. Some embodiments of the present invention generate barcodes as the credential, for example a linear barcode, such as a Universal Product Code (UPC), or a matrix barcode, such as a Quick Response (QR) code. Other examples of credentials used by some embodiments of the present invention include, but are not limited to passwords, identification numbers, pass phrases, and/or other identifying elements that may be reproduced or scanned for access to the secure container. In some embodiments of the present invention, the access credential unlocks a controlled area, such as safe deposit box 108 of FIG. 1. In some embodiments, a credential is useful for only a specified period of time. For example, a QR code is generated to unlock a specific safe deposit box. The QR code has a limited use for 15 minutes. That is, the QR code operates to unlock the specific safe deposit box during a 15 minute window from the time the QR code is generated, or from the time the QR code is provided to the authorized user. The expiration time associated with an access credential may be designated according to a contractual arrangement.

In some embodiments of the present invention, access management program 200 generates an access credential for more than one controlled area, such as a numbered safe deposit box and the vault containing the safe deposit box. In an example, safe deposit box number 580 is located inside vault number 500. Access management program 200 generates an access credential in the form of a QR code on a smart device. The generated QR code unlocks vault number 500 and unlocks safe deposit box number 580.

Access management program 200 identifies when a secure container, or controlled area, is accessed (step 216). In some embodiments of the present invention, access is the opening of the secure container, such as when a safe deposit box is opened. In some embodiments of the present invention, access management program 200 identifies access when a controlled area is unlocked by an access credential. In some embodiments, a safe deposit box contains sensors that indicate when the safe deposit box is physically opened. In this case, access management program 200 identifies access when the sensors indicate an enclosed controlled area is opened. In some embodiments, cameras located in proximity to a controlled area facilitate the identification of an access event. In this case, access management program 200 identifies access when the cameras indicate the controlled area is opened.

Access management program 200 records access to the secure container on the shared ledger (step 218). In some embodiments of the present invention, access management program 200 records a timestamp and other identifying information of the access event, such as the location of activity and the activity name. In some embodiments, the recorded access event is encrypted with a unique cryptographic signature. The cryptographic signature signifies that the access event was performed by a specific authorized user.

Access management program 200 identifies when a secure container, or controlled area, is closed (step 220). In some embodiments of the present invention, a controlled area, such as safe deposit box 108 of FIG. 1, automatically locks when closed. In some embodiments of the present invention, access management program 200 identifies the secure container as being closed when it is locked. In some embodiments, the controlled area, such as safe deposit box 108, contains sensors that detect when the secure container is physically closed. For example, access management program 200 identifies the safe deposit box to be closed when the sensors detect that the safe deposit box is closed. In some embodiments, cameras located in proximity to a controlled area facilitate the identification of the controlled area as being closed. In this case, access management program 200 identifies the safe deposit box as being closed when the cameras indicate the controlled area is closed. Some embodiments of the present invention disable a credential used to open the safe deposit box upon identifying the safe deposit box as being closed.

Access management program 200 records a closing event on the shared ledger (step 222). In some embodiments of the present invention, access management program 200 records a timestamp and other identifying information of the closing event, such as the location of activity and the activity name. In some embodiments, the recorded closing event is encrypted with a unique cryptographic signature. The cryptographic signature signifies that the closing event was performed by a specific authorized user.

In an example, Abel desires physical access to safe deposit box number 508. Access management program 200 generates a QR code on a smart device. Abel utilizes the QR code on the smart device to unlock safe deposit box number 508. Abel opens safe deposit box number 508. Access management program 200 identifies the opening. Access management program 200 records the opening of safe deposit box number 508 on a shared ledger. The recording of the opening includes a timestamp for when safe deposit box number 508 was opened. The shared ledger is controlled by a blockchain platform on a peer-to-peer network established between contracting parties associated with safe deposit box number 508. Abel closes safe deposit box number 508. Access management program 200 identifies the closing of the safe deposit box. Access management program 200 records the closing of safe deposit box number 508 on the shared ledger. The recording of the closing includes a timestamp for when safe deposit box number 508 was closed.

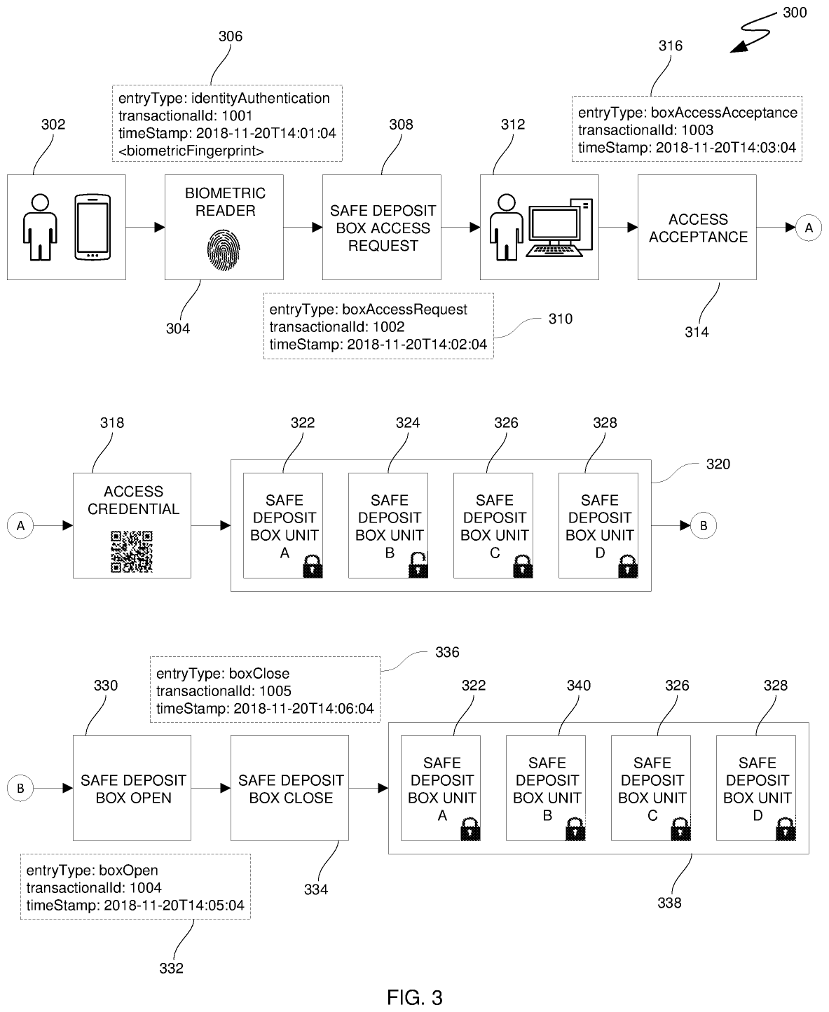

FIG. 3 is a schematic view of computer system 300, illustrating a computing environment for managing safe deposit box access, in accordance with an embodiment of the present invention. In this embodiment, a safe deposit box access management method is depicted with functions in a similar role as discussed with respect to access management program 200.

The method begins at step 302 with a user seeking physical access to safe deposit box ‘B.’

The method proceeds to step 304, where the user provides identifying information for authentication. In this example, biometric data in the form of fingerprint scan data is provided by the user via a biometric reader. Biometric authentication systems compare the fingerprint scan data provided by the user to authorized fingerprint scan data stored in a database. The authorized fingerprint scan data representing persons authorized to access safe deposit box B. The authentication of the user is recorded to a shared ledger that is part of a blockchain platform on a peer-to-peer network established between contracting parties associated with safe deposit box B. Alternatively, the identify of the authenticated user is recorded. In some embodiments of the present invention both the authentication and the identify of the authenticated user are recorded to the shared ledger.

Screenshot 306 is a screenshot of the recordation of the identity authentication on the shared ledger. As seen in screenshot 306, the recordation includes an entry type of “identityAuthentication,” a transactional ID of “1001,” a timestamp of “2018-11-20T14:01:04,” and an attachment of the fingerprint scan data provided by the requesting user.

The method proceeds to step 308, where an access request is submitted by the requesting user. After authentication of the requesting user, the biometric reader provides the requesting user with an option to submit an access request.

Screenshot 310 is a screenshot of the recordation of the access request on the shared ledger. As seen in screenshot 310, the recordation includes an entry type of “boxAccessRequest,” a transactional ID of “1002,” and a timestamp of “2018-11-20T14:02:04.”

The method proceeds to step 312, where the access request is sent to the administrator of safe deposit box B.

The method proceeds to step 314, where an acceptance of the access request is submitted by the administrator to the requesting user.

Screenshot 316 is a screenshot of the recordation of the acceptance on the shared ledger. As seen in screenshot 316, the recordation includes an entry type of “boxAccessAcceptance,” a transactional ID of “1003,” and a timestamp of “2018-11-20T14:03:04.”

The method proceeds to step 318, where a credential for access to safe deposit box B is generated. The credential is a QR code generated on a smart device. The generated QR code can be used to unlock safe deposit box B.

The method proceeds to step 320, where the requesting user unlocks the safe deposit box B with the credential generated upon acceptance of the access request. As depicted in step 320, safe deposit box A (322), safe deposit box C (326), and safe deposit box D (328) remain locked while safe deposit box B (324) is unlocked by the requesting user with the generated QR code.

The method proceeds to step 330, where the safe deposit box is opened. Sensors in safe deposit box B detect when safe deposit box B is opened and record the event to the shared ledger.

Screenshot 332 is a screenshot of the recordation of the access event on the shared ledger. As seen in screenshot 332, the recordation includes an entry type of “boxOpen,” a transactional ID of “1004,” and a timestamp of “2018-11-20T14:05:04.”

The method proceeds to step 334, where the safe deposit box is closed by the requesting user. Sensors in safe deposit box B detect when safe deposit box B is closed and record the closing event on the shared ledger.

Screenshot 336 is a screenshot of the recordation of the closing event on the shared ledger. As seen in screenshot 336, the recordation includes an entry type of “boxClose,” a transactional ID of “1005,” and a timestamp of “2018-11-20T14:06:04.”

The method proceeds to step 338, where safe deposit box B automatically locks when the sensors detect that the safe deposit box is closed. As depicted in step 338, safe deposit box A (322), safe deposit box C (326), and safe deposit box D (328) remain locked, while safe deposit box B (340) is locked when safe deposit box B is closed.

FIG. 4 is a block diagram of components of a computing device, generally designated 400, in accordance with an embodiment of the present invention. In one embodiment, computing system 400 is representative of access management server 110 within computing environment 100, in which case access management server 110 includes access management program 200.

It should be appreciated that FIG. 4 provides only an illustration of one implementation and does not imply any limitations with regard to the environments in which different embodiments may be implemented. Many modifications to the depicted environment may be made.

Computing system 400 includes processor(s) 402, cache 406, memory 404, persistent storage 410, input/output (I/O) interface(s) 412, communications unit 414, and communications fabric 408. Communications fabric 408 provides communications between cache 406, memory 404, persistent storage 410, communications unit 414, and input/output (I/O) interface(s) 412. Communications fabric 408 can be implemented with any architecture designed for passing data and/or control information between processors (such as microprocessors, communications, and network processors, etc.), system memory, peripheral devices, and any other hardware components within a system. For example, communications fabric 408 can be implemented with one or more buses or a crossbar switch.

Memory 404 and persistent storage 410 are computer readable storage media. In this embodiment, memory 404 includes random access memory (RAM). In general, memory 404 can include any suitable volatile or non-volatile computer readable storage media. Cache 406 is a fast memory that enhances the performance of processor(s) 402 by holding recently accessed data, and data near recently accessed data, from memory 404.

Program instructions and data used to practice embodiments of the present invention may be stored in persistent storage 410 and in memory 404 for execution by one or more of the respective processor(s) 402 via cache 406. In an embodiment, persistent storage 410 includes a magnetic hard disk drive. Alternatively, or in addition to a magnetic hard disk drive, persistent storage 410 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 410 may also be removable. For example, a removable hard drive may be used for persistent storage 410. Other examples include optical and magnetic disks, thumb drives, and smart cards that are inserted into a drive for transfer onto another computer readable storage medium that is also part of persistent storage 410.

Communications unit 414, in these examples, provides for communications with other data processing systems or devices. In these examples, communications unit 414 includes one or more network interface cards. Communications unit 414 may provide communications through the use of either or both physical and wireless communications links. Program instructions and data used to practice embodiments of the present invention may be downloaded to persistent storage 410 through communications unit 414.

I/O interface(s) 412 allows for input and output of data with other devices that may be connected to computer system 400. For example, I/O interface(s) 412 may provide a connection to external device(s) 416 such as a keyboard, keypad, a touch screen, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 410 via I/O interface(s) 412. I/O interface(s) 412 also connect to display 418.

Display 418 provides a mechanism to display or present data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for ensuring physical access control of a lockbox comprising:
monitoring physical access of a lockbox under controlled access according to a contract governing control of the lockbox;
generating an authentication of a user by determining a first biometric reading stored for reference matches a second biometric reading submitted for the authentication, the first biometric reading associated with a user having authority to gain physical access to the lockbox according to the contract;
recording an identity of the authenticated user to a ledger accessible over a peer-to-peer network of parties to the contract, the ledger supporting the contract by linking access activity of the parties using cryptography, the authenticated user being the user for whom the authentication was generated;
identifying a request for physical access to the lockbox submitted by the authenticated user;
submitting the request to an administrator for acceptance, the administrator being an authorized party of the contract;
responsive to receiving an acceptance from the administrator, providing to the authenticated user a credential permitting access to the lockbox;
responsive to use of the credential and opening of the lockbox with the credential, recording to the ledger the opening of the lockbox as an access event initiated by the authenticated user; and
responsive to identifying the lockbox as being closed at a time after the access event is recorded, recording a closing event on the ledger and securing the lockbox from access with the credential.

2. The method of claim 1, wherein the peer-to-peer network is on a blockchain platform tied to the contract.

3. The method of claim 1, wherein:
the peer-to-peer network includes a near field network accessible by the parties to the contract; and
the request for physical access to the lockbox is submitted over the near field network.

4. The method of claim 3, wherein generating an authentication of the user comprises:
receiving an authentication request from a mobile device communicating over the near field network; and
receiving the second biometric reading from the mobile device.

5. The method of claim 3, wherein the near field network is a visible light communications system.

6. The method of claim 1, further comprising:
recording to the ledger the acceptance of the request by the authorized party of the contract.

7. (canceled)

8. A computer program product comprising one or more computer-readable storage medium collectively having a set of instructions stored therein which, when executed by a processor, causes the processor to ensure physical access control of a lockbox by:
monitoring physical access of a lockbox under controlled access according to a contract governing control of the lockbox;
generating an authentication of a user by determining a first biometric reading stored for reference matches a second biometric reading submitted for the authentication, the first biometric reading associated with a user having authority to gain physical access to the lockbox according to the contract;
recording an identity of the authenticated user to a ledger accessible over a peer-to-peer network of parties to the contract, the ledger supporting the contract by linking access activity of the parties using cryptography, the authenticated user being the user for whom the authentication was generated;
identifying a request for physical access to the lockbox submitted by the authenticated user;
submitting the request to an administrator for acceptance, the administrator being an authorized party of the contract;
responsive to receiving an acceptance from the administrator, providing to the authenticated user a credential permitting access to the lockbox;
responsive to use of the credential and opening of the lockbox, recording to the ledger the request associated with the authenticated user and an access event initiated by the authenticated user;
responsive to the lockbox being closed at a time after the access event is recorded, recording a closing event on the ledger; and
responsive to the closing event, securing the lockbox from access with the credential.

9. The computer program product of claim 8, wherein the peer-to-peer network is on a blockchain platform tied to the contract.

10. The computer program product of claim 8, wherein:
the peer-to-peer network includes a near field network accessible by the parties to the contract; and
the request for physical access to the lockbox is submitted over the near field network.

11. The computer program product of claim 10, wherein generating an authentication of the user comprises:
receiving an authentication request from a mobile device communicating over the near field network; and
receiving the second biometric reading from the mobile device.

12. The computer program product of claim 10, wherein the near field network is a visible light communications system.

13. The computer program product of claim 8, further comprising:
recording to the ledger the acceptance of the request by the authorized party of the contract.

14. A computer system for ensuring physical access control of a lockbox, the computer system comprising:
a processor(s) set; and
a computer readable storage medium having program instructions stored therein;
wherein:
the processor(s) set executes the program instructions that cause the processor(s) set to ensure physical access control of a lockbox by:
monitoring physical access of a lockbox under controlled access according to a contract governing control of the lockbox;
generating an authentication of a user by determining a first biometric reading stored for reference matches a second biometric reading submitted for the authentication, the first biometric reading associated with a user having authority to gain physical access to the lockbox according to the contract;
recording an identity of the authenticated user to a ledger accessible over a peer-to-peer network of parties to the contract, the ledger supporting the contract by linking access activity of the parties using cryptography, the authenticated user being the user for whom the authentication was generated;
identifying a request for physical access to the lockbox submitted by the authenticated user;
submitting the request to an administrator for acceptance, the administrator being an authorized party of the contract;
responsive to receiving an acceptance from the administrator, providing to the authenticated user a credential permitting access to the lockbox;
responsive to use of the credential and opening of the lockbox, recording to the ledger the request associated with the authenticated user and an access event initiated by the authenticated user;
responsive to the lockbox being closed at a time after the access event is recorded, recording a closing event on the ledger; and
responsive to the closing event, securing the lockbox from access with the credential.

15. The computer system of claim 14, wherein the peer-to-peer network is on a blockchain platform tied to the contract.

16. The computer system of claim 14, wherein:
the peer-to-peer network includes a near field network accessible by the parties to the contract; and
the request for physical access to the lockbox is submitted over the near field network.

17. The computer system of claim 16, wherein generating an authentication of the user comprises:
receiving an authentication request from a mobile device communicating over the near field network; and
receiving the second biometric reading from the mobile device.

18. The computer system of claim 16, wherein the near field network is a visible light communications system.

19. The computer system of claim 14, further comprising:
recording to the ledger the acceptance of the request by the authorized party of the contract.

20. (canceled)
